(19) United States
(12) Patent Application Publication
(10) Pub. No.: US 2006/0044112 A1
(43) Pub. Date: Mar. 2, 2006

(54) Wearable RFID reader and system

(76) Inventor: Raj Bridgelall, Morgan Hill, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/931,462

(22) Filed: Aug. 31, 2004

(51) Int. Cl. H04Q 5/22

(52) U.S. Cl. 340/10.1; 340/572.8

(57) ABSTRACT

A wearable RFID system of wearing on the body of a user is disclosed. The wearable RFID system comprises an RFID reader, a network controller coupled to the RFID reader and a network transceiver coupled to the network controller. The wearable RFID reader reads data stored on RFID tags, such as a product code. This data can then be sent to the network controller and then to the network transceiver. The network transceiver can send the information to an external network for processing or storage.

### TECHNICAL FIELD

This invention relates to the field of radio frequency identification systems and, more specifically, to a wearable RFID reader.

### BACKGROUND

Radio Frequency Identification (RFID) systems are of use in many different areas. For example, RFID systems can be used to track goods as they move throughout the supply chain. A typical RFID system comprises an RFID reader, at least one RFID tag affixed to an item of interest and, optionally, a computer system coupled to the RFID reader to process data.

RFID tags include memory that typically stores data concerning the item to which the RFID tag is attached. For example, an RFID tag may be attached to a product or a product's packaging such as the packaging for a drill. The RFID tag attached to the drill's packaging can store a product identification code that uniquely identifies the item.

RFID readers send interrogation signals to RFID tags and receive responses from the RFID tag. RFID readers can be handheld or permanently installed. RFID readers, depending on the needs of the end user and the capability of the RFID tags, can read data from the RFID tag and/or write information to the RFID tag. In the example discussed above, an RFID reader can be used to read the product identification code from the RFID tag attached to the packaging of the drill.

The computer system receives data from the RFID reader and can then store, process or otherwise use the collected data. In the example discussed previously, the computer system can receive the product identification code from the RFID reader and then use the product identification code in conjunction with a database program to retrieve pricing information for the drill. The pricing information can be sent back to a device that is part of the computer system. For example, the pricing information may be sent to a point-of-sale (POS) system.

While typical RFID systems, with handheld or fixed RFID readers, are ideal in many circumstances, they have drawbacks. For example the RFID readers can be cumbersome to use. Also, RFID systems require a user to point the RFID reader at different tags. The repetitive nature of pointing and activating the RFID reader can be tiring to individual users. Finally, the use of current RFID systems requires at least some training. Additional training results in added costs to a business. What is needed is an RFID system that simplifies the reading process and minimizes the cost of training.

### SUMMARY OF THE INVENTION

In one embodiment of the present invention, a wearable RFID system for wearing on the body of a user is disclosed. The wearable RFID system includes a wearable RFID reader operable to receive data from an RFID tag and a network controller coupled to the wearable RFID reader for receiving the data received by the wearable RFID reader. In one embodiment the wearable RFID reader is a RFID glove that can be used to read RFID tags. In another aspect of the present invention, the wearable RFID reader is a RFID hat that can be used to read RFID tags

In another embodiment of the present invention, a method for handling a package using a wearable RFID reader is disclosed. In the method package product data is read from a package RFID tag associated with the package using the wearable RFID reader. Next, pallet data from a pallet RFID tag associated with a pallet is read when the wearable RFID reader. Then, the package product data and the pallet data are evaluated to determine if the package is associated with the pallet. In one embodiment, the wearable RFID reader is a RFID

### BRIEF DESCRIPTION OF THE DRAWINGS

The present invention will hereinafter be described in conjunction with the following drawing figures, wherein like numerals denote like elements, and:

FIG. 1 illustrates a body area network in accordance with the teachings of the present invention;

FIG. 2 illustrates the components of a body area network in accordance with the teachings of the present invention;

FIG. 3 illustrates an exemplary RFID glove, in accordance with the teachings of the present invention;

FIG. 4 illustrates an exemplary RFID hat, in accordance with the teachings of the present invention;

FIG. 5 is a flowchart illustrating an exemplary use of the present invention to sort containers when building pallets; and

FIG. 6 is a flowchart of a method of writing to RFID tags in accordance with the teachings of the present invention.

### DETAILED DESCRIPTION OF A PREFERRED EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

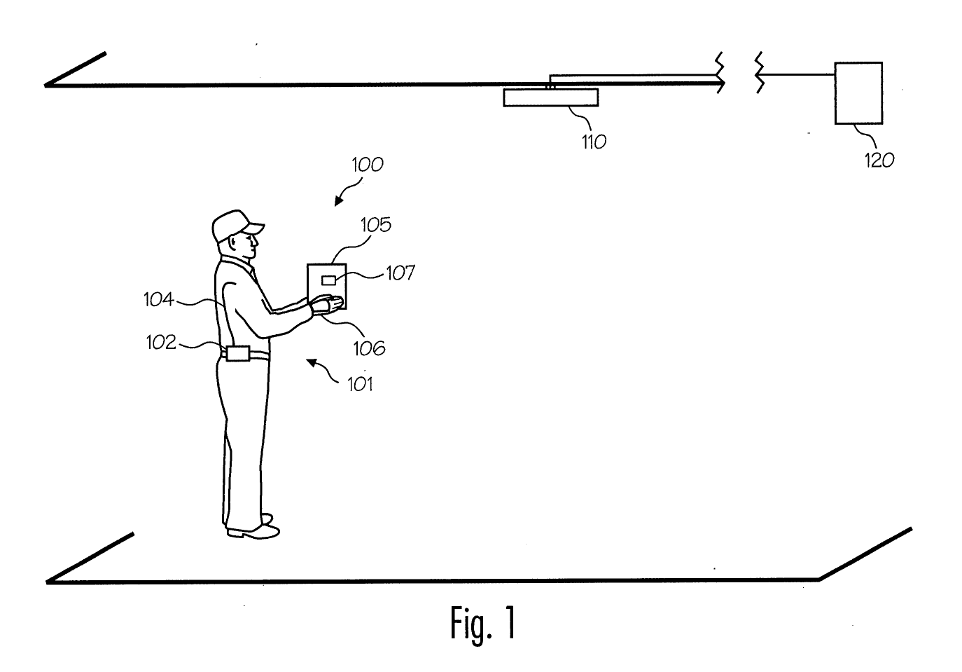

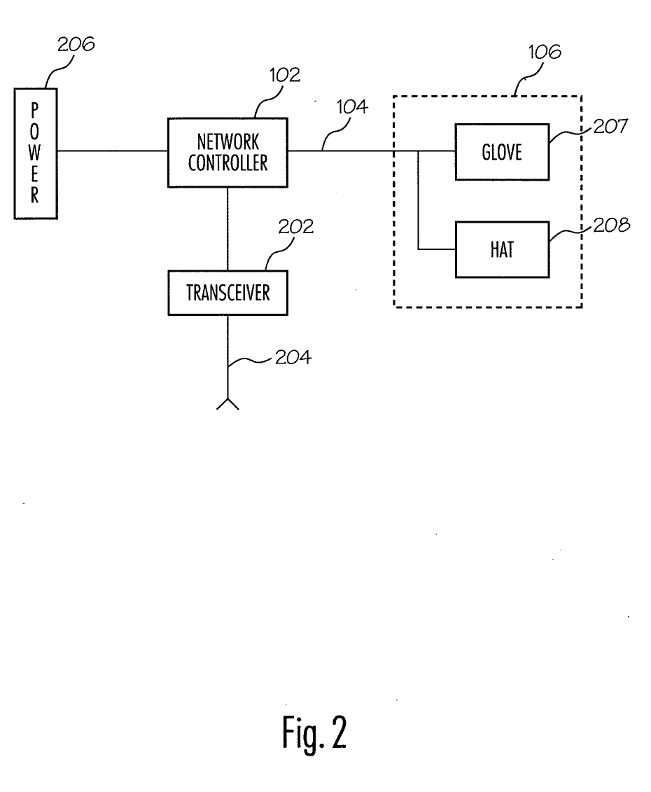

FIGS. 1-2 illustrate a system for use with one embodiment of the present invention. Illustrated is a user 100 wearing a body area network 101. Body area network 101 comprises a network controller 102 coupled to a wearable RFID reader 106 via a conductive thread backbone 104. As illustrated in FIG. 1, user 100 is carrying a package 105 upon which a RFID tag 107 is mounted. In a typical embodiment, the RFID tag 107 stores information regarding the package 105 such as a product identification number or other information.

The body area network 101 further includes a wireless transceiver 202 and antenna 204 coupled to the network controller 102 as seen in FIG. 2. Additionally, a power supply 206 can be coupled to network controller 102. As illustrated in FIG. 1, only a single item is attached to the body area network 101, that is, the wearable RFID reader 106. However, multiple devices can be part of body area network 101, including security access devices, location finding devices and the like.

Network controller 102 can be any device that controls the transmission and reception of data over the body area network 101. Network controller 102 implements any necessary protocols for data transmission. Network controller 102 can also comprise any components needed for any processing and storage of data. For example, in one embodiment any data received can be stored in the body area network in memory coupled to the body area network until needed.

Wireless network transceiver 202 couples to network controller 102. Wireless network transceiver 202 can be any device that can send data to and transmit data from network controller 102. Wireless network transceiver 202 can be coupled to antenna 204 which allows wireless network transceiver 202 to communicate with a wireless network access point 110. While a wireless network transceiver 202 is shown, in one embodiment of the present invention the network controller 201 could be coupled to an external computer system via a wired connection. Of course, this embodiment would inhibit the mobility of the user 100.

Wireless access point 110 can be any device capable of communicating with other wireless devices and sending data to a computer system 120. In one embodiment, wireless network access point 110 can be an 802.11 compatible access point. In embodiments where data can be stored on the body area network 101, a wireless network transceiver 202 and wireless access port 110 may not be needed.

Energy source 206 can be any energy source capable of powering the components of body area network 101. In one embodiment, energy source 206 can be a set of batteries, preferably rechargeable batteries such as lithium polymer batteries. In an alternative embodiment, energy source 206 can be a solar energy source providing power for the body area network 101 and/or recharging on board batteries. Alternatively, energy source 206 can be a regenerative energy source powered by the movement of the user 100.

Various devices can connect to the body area network 101. As shown in FIG. 1, the wearable RFID reader 106 can be attached to body area network 101. Wearable RFID reader 106 can be any device that connects to body area network 101 and can function as a RFID reader 106, regardless of where the RFID reader 106 is attached. In one embodiment of the present invention, and as seen in FIG. 2, wearable RFID reader 106 can be a RFID glove 207 and a RFID hat 208. When connecting into the body area network 101, the RFID glove 207 and RFID hat 208 comprise embedded RFID readers that can read RFID tags 107 mounted on a box, pallet or other object when that object can be manipulated by the user. The information gathered from the RFID reader can be integrated into either the RFID glove 207 or the RFID hat 208.

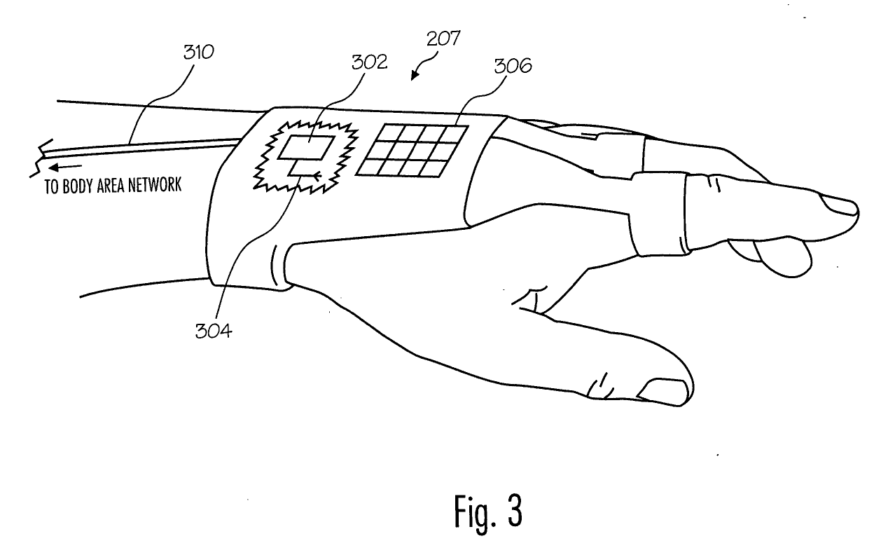

An exemplary RFID glove 207 in accordance with the teachings of the present invention is illustrated in FIG. 3. RFID glove 207, as illustrated, can be a fingerless, palmless glove. However, any type of hand covering can be used as the RFID glove 207. RFID glove 207 includes RFID electronics 302 necessary to implement a RFID reader. RFID reader design is well known in the art. Different RFID reader designs are shown in the RFID Handbook, by Klaus Finkenzeller, which is hereby incorporated by reference. Coupled to the RFID reader electronics 302 can be an antenna 304. In one embodiment, antenna 304 can be a directional antenna such as a Yagi antenna, although any appropriate antenna can be used.

RFID glove 207 optionally includes various input/output devices. RFID glove 207 can include an input device such as a keypad 306, used if alphanumeric entry is needed. Also, a display (not pictured) can be included that provides visual feedback to the user. Additionally, in one embodiment, RFID glove 106 can include a wireless transceiver accessing a wireless network without using the wireless transceiver 202 of the body area network 101.

In one embodiment, RFID glove 207 can be coupled to body area network 101 via a glove cable 310 which couples to the conductive thread backbone 104 and, therefore, into the body area network 101. Alternatively, RFID glove 207 can be coupled to the body area network 101 by a short range wireless connection, such as a connection using the BLUETOOTH protocol.

RFID glove 207 can be powered from body area network 101 or may contain its own internal power source. In one embodiment, RFID glove 207 utilizes a rechargeable battery for power, such as a lithium polymer battery.

In one embodiment, the RFID electronics 302 of the RFID glove 207 will initiate an interrogation of the RFID tag 107 when the RFID tag 107 is within a preset proximity of the RFID glove 207. For example, if the user 100 picked up a box having the RFID tag 107 affixed, the RFID electronics 302 can be set to interrogate the RFID tag 107 at the distance from the RFID glove 207 to the box. This can be done in several ways including by adjusting the strength of the interrogation signal sent by RFID electronics 302. Alternatively, RFID glove 207 can be triggered by the user using a trigger 308 to start an interrogation. The trigger 308 can be placed on the RFID glove 207 or anyplace else on the user. In one embodiment, a visual or aural indication that the RFID electronics 302 was triggered can be provided.

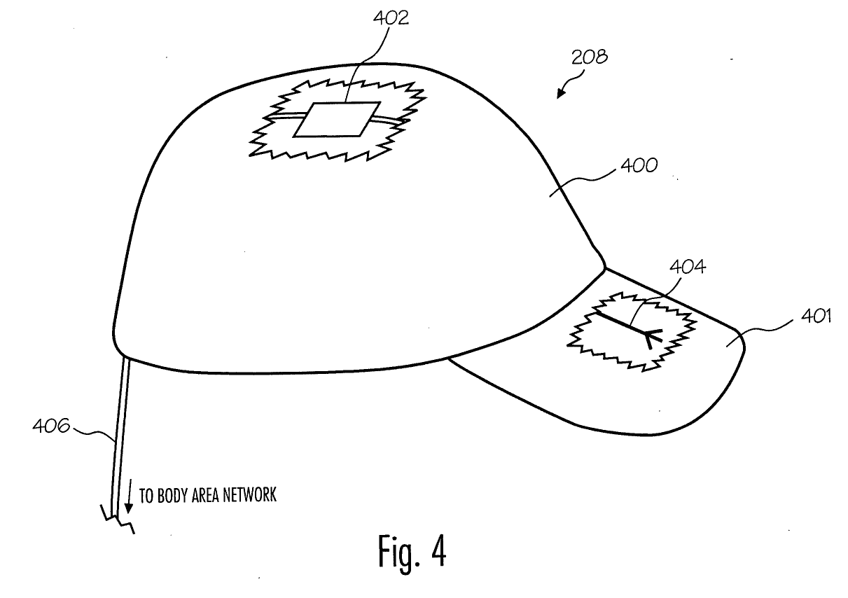

An exemplary RFID hat 208, in accordance with the teachings of the present invention, is shown in FIG. 4. As illustrated in FIG. 4, RFID hat 208 resembles the well known baseball cap style hat having a head portion 400 attached to a bill portion 401. Of course the type of hat shown is for exemplary purposes only and can be any type of head covering in which RFID reader electronics can be placed. RFID hat 208 can comprise similar components as RFID glove 207. For example, RFID hat 208 will include a RFID reader 402 coupled to a RFID antenna 404. In one embodiment, the RFID antenna 404 can be integrated into the bill 401 of the RFID hat 208. RFID hat 208 may further include a wireless transceiver for wirelessly accessing a wireless network without the use of wireless transceiver 202 of the body area network 101.

RFID hat 208 can be coupled to body area network 101 via a hat cable 406. In another embodiment, RFID hat 208 can be coupled to body area network 101 via a short range connection such as a BLUETOOTH connection.

RFID hat 208 can be powered from an onboard power source such as a rechargeable battery. Alternatively, RFID hat 208 can receive power over the conductive thread backbone 104 of the body area network 101.

In one embodiment, the RFID reader 402 of the RFID hat 208 will initiate an interrogation of the RFID tag 107 when the RFID tag 107 is within a present proximity of the RFID hat 208. For example, if the user 100 picked up a box having the RFID tag 107 affixed, the RFID reader 402 will be set to interrogate the RFID tag 107 at the distance from the RFID hat 208 to the box. This can be done by one embodiment by adjusting the strength of the interrogation signal of RFID reader 402. Alternatively, RFID hat 208 can be triggered by the user to start an interrogation. The trigger can be placed on the RFID hat 208 or anyplace else on the user. In one embodiment, a visual or aural indication that the RFID reader 402 was triggered can be provided.

The RFID system, as shown in FIGS. 1-4 can be used in many different applications. By including an RFID reader in a wearable device, a user can process RFID tagged objects without the need for handling a separate reader. This can lead to increased productivity. Integrating wearable RFID readers into a body area network allows for a robust system where a user can read a RFID tagged object by simply picking up the object. The data read from the RFID tag can be sent to a computer for processing or other reasons.

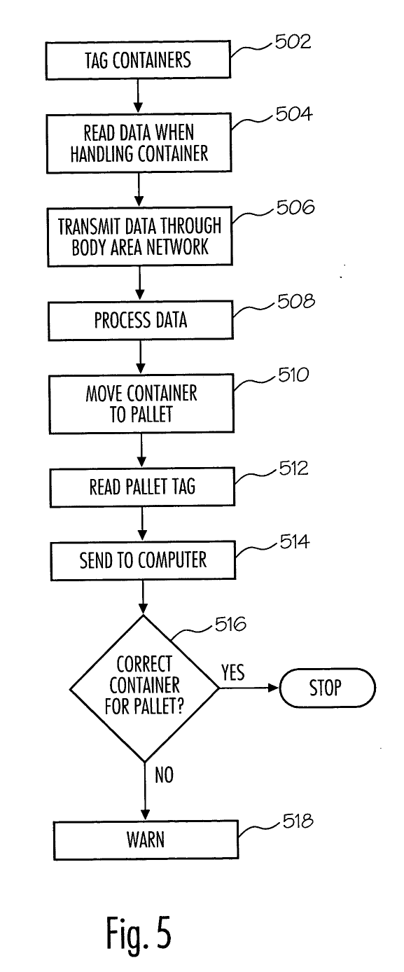

FIG. 5 is a flowchart illustrating an exemplary use of the present invention to sort containers of products. This is useful, for example, when building pallets. A pallet typically comprises multiple units of containers or boxes that are packaged for transportation on board trucks, trains and the like. Typically, a manufacturer builds pallets of a product that are then sent to warehouses or distributors and, eventually the product is sent further down the supply chain. Problems can occur when the wrong item is placed on a pallet. A wrong item can be the wrong product, the wrong version of the product and the like.

To prevent the placement of incorrect containers on a pallet, a user, equipped with the RFID glove 207 or the RFID hat 208, handles a container, such as a box or other subset of a pallet. The RFID glove 207 or RFID hat 208 can read the RFID tag of the container to identify the container.

A method for accurately building pallets is illustrated in FIG. 5. In a first step, containers that are to be placed in a pallet will have an RFID tag attached (step 502). In one embodiment, the RFID tag can contain data related to the identity of the container and the container's contents.

The RFID reader, embedded in the RFID glove 207, the RFID hat 208 or some other article of clothing, reads the data from the RFID tag (step 504). In one exemplary embodiment, the RFID tag can be read when the tagged object is handled by a user wearing the RFID glove 207. This RFID tag data can then be sent from the RFID glove 207, RFID hat 208, or other wearable reader through the body area network 101 to the network controller 102 and to the wireless access point 110 via the wireless transceiver 202 to the computer system 120 (step 506). The RFID tag data can then be processed and stored at the computer system 120 (step 508).

The user then moves the container to the pallet (step 510). The RFID glove 207, RFID hat 208 or other wearable reader reads a pallet RFID tag when the wearable RFID reader 106 moves close to the pallet RFID tag (step 512). The pallet RFID tag can include information regarding what containers are to be placed in the particular pallets.

The pallet data from the pallet RFID tag can be sent, as before, to the computer system 120 (step 514). The RFID tag data can be evaluated along with the pallet data to see if the correct container was placed on the pallet (step 516). If the correct container was placed, the user continues to build the pallet. If an incorrect container is placed, the user is informed using some type of feedback, such as an audible tone (step 518).

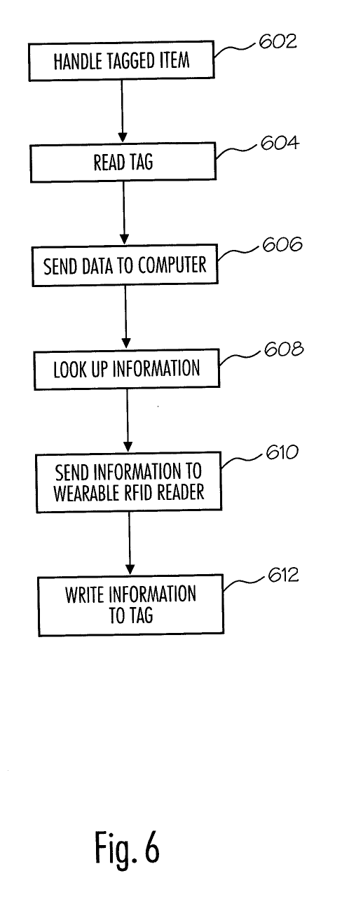

The method as described in conjunction with FIG. 5 can be used to sort items in many different embodiments. In the method as shown in FIG. 5, the various RFID tags were simply read by the wearable RFID reader. FIG. 6 is a flowchart of a method of writing to RFID tags in accordance with the teachings of the present invention.

In a first step, a user, in accordance with the teachings of the present invention, handles an object with an RFID tag attached (step 602). For example, the object may be a box containing a drill. The RFID glove 207, RFID hat 208 or other wearable RFID reader 106 then reads data from the RFID tag (step 604). For example, the data could be product information, including a product identification number.

The data can be sent, in one embodiment, via the body area network 101, to the computer system 120 (step 606). The computer system 120, in one embodiment, uses the data to retrieve additional information (such as pricing information) (step 608). This information can be sent back to the RFID glove 207, RFID hat 208 or other wearable RFID reader 106 via the body area network 101 (step 610). The RFID glove 207, RFID hat 208 or other wearable RFID reader 106 then writes this information to the RFID tag (step 612). For example, the RFID tag attached to the box containing the drill that at first had only product information stored may now have retail price information stored as well. In this example, as the user handles other items, those items also have additional information, such a pricing data, written to them.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A wearable RFID system for wearing on the body of a user comprising:
a wearable RFID reader operable to receive data from an RFID tag; and
a network controller coupled to the wearable RFID reader for receiving the data received by the wearable RFID reader.

2. The wearable RFID system of claim 1 wherein the wearable RFID reader is a RFID glove.

3. The wearable RFID system of claim 2 wherein the RFID glove is wirelessly coupled to the network controller.

4. The wearable RFID system of claim 2 wherein the RFID glove initiates an interrogation of the RFID tag based on a proximity to the RFID tag.

5. The wearable RFID system of claim 2 wherein the RFID glove initiates an interrogation of the RFID tag when initiated by a trigger.

6. The wearable RFID system of claim 1 wherein the wearable RFID reader is a RFID hat.

7. The wearable RFID system of claim 6 wherein the RFID hat is wirelessly coupled to the network controller.

8. The wearable RFID system of claim 6 wherein the RFID hat initiates an interrogation of the RFID tag based on a proximity to the RFID tag.

9. The wearable RFID system of claim 6 wherein the RFID hat initiates an interrogation of the RFID tag when initiated by a trigger.

10. The wearable RFID system of claim 1 further comprising a network transceiver coupled to the network controller for sending the data to an external network.

11. The wearable RFID system of claim 10 wherein the network transceiver is a wireless network transceiver.

12. The wearable RFID system of claim 1 further comprising an onboard power supply.

13. The wearable RFID system of claim 12 wherein the onboard power supply is a battery.

14. The wearable RFID system of claim 12 wherein the onboard power supply is a solar power system.

15. The wearable RFID system of claim 12 wherein the onboard power supply is a regenerative power supply powered by a user.

16. The wearable RFID system of claim 1 wherein the RFID reader further includes an RFID writer for writing information to an RFID tag.

17. The wearable RFID system of claim 4 wherein the RFID writer is operable to store pricing information to an RFID tag.

18. The wearable RFID system of claim 1 wherein the data is stored at the network controller for future retrieval.

19. A method for handling objects using a wearable RFID reader comprising:
reading first product data when the wearable RFID reader is within a preset distance from a first RFID tag associated with a first object;
reading second product data when the wearable RFID reader is within a preset distance from a second RFID tag associated with a second object;
evaluating the first product data and the second product data to determine if the first product is associated with the second product.

20. The method of claim 19 wherein the wearable RFID reader is a RFID glove reader.

21. The method of claim 19 wherein the wearable RFID reader is a RFID hat.

22. The method of claim 19 wherein the first object is a package and the second object is a pallet comprising multiple related packages.

23. The method of claim 22 further comprising the step of writing to the first RFID tag when the wearable RFID reader is within a preset distance.

24. The method of claim 22 further comprising generating a warning if the package is not associated with the pallet.

25. The method of claim 23 further comprising the step of writing pricing information to the package RFID tag.
